(19) United States
(12) Patent Application Publication
(10) Pub. No.: US 2014/0292010 A1
(43) Pub. Date: Oct. 2, 2014

(54) Transformable Adaptive Gripper System

(71) Applicants: Robert Graupner, Augsburg (DE); Klaus Drechsler, Feldkirchen (DE); Stefan Schmitt, Augsburg (DE); Jakob Wölling, Augsburg (DE)

(72) Inventors: Robert Graupner, Augsburg (DE); Klaus Drechsler, Feldkirchen (DE); Stefan Schmitt, Augsburg (DE); Jakob Wölling, Augsburg (DE)

(73) Assignee: Fraunhofer-Gesellschaft zur Forderung der angewandten Forschung e.v., Münich (DE)

(21) Appl. No.: 13/882,096

(22) PCT Filed: Oct. 21, 2011
(86) PCT No.: PCT/EP2011/068465

§ 371 Date: Jun. 27, 2013

(30) Foreign Application Priority Data
Oct. 28, 2010 (DE) 10 2010 043 036.6

(51) Int. Cl. B25J 15/00

(52) U.S. Cl. CPC B25J 15/0023; B25J 15/0071; B25J 15/0076
USPC 294/61; 294/213; 294/216

(57) ABSTRACT

An end effector that includes: a flexible container which contains a filler, wherein the filler is switchable between a flowable or deformable state and a rigid or dimensionally stable state, and one or more working elements for gripping, temperature regulation and/or compaction.

### BACKGROUND OF THE INVENTION

Fiber-reinforced plastics are already established in many technical areas, including as a lightweight construction material which can save weight of an order of magnitude of 30% in comparison to the classic metal construction. CFRP (carbon-fiber-reinforced plastic) is widely used specifically in the air travel area. A substantial reason which prevents even greater use resides in the production costs which are still comparatively high. These, in turn, are caused by a not insignificant proportion of manual working steps which have not yet been automated in the “handling” of the fibers(cutting out, preforming, deforming, draping).

At present, various approaches are known for automating the handling of fibers. Examples in this context include the following approaches:
fiber patch preforming (disadvantage: very low depositing rates).
Robot-assisted depositing of multi-axial fabric (MAF) and other large-area semi-finished products at higher depositing rates: attaching a tool (what are referred to as end effectors) to a commercially available robot (advantageous flexibility of a 6-axle articulated-arm robot in comparison to a portal system) and picking up the trimmed, flat semi-finished product and depositing the latter in a mold. The semi-finished product is actually fixed in the end effector via vacuum grippers, needle grippers or ice grippers.

Different procedures are used in this case depending on the complexity of the mold into which items are to be deposited. Surfaces with a simple curvature can be handled by means of a rolling movement of a cylindrical end effector. However, this only functions in the case of simple geometries. In the case of more complex geometries, the operation has to be carried out with rigid pick-ups which have to be adapted for each semi-finished product and/or component and for each depositing step. This is a problem specifically in the case of the small batch sizes customary in the CFRP area, since additional investment and development is thus required at the beginning of production of new components. In particular in the case of assembly of preforms from partially pre-stabilized fiberblanks, the gripper geometries have to be adapted very precisely to the semi-finished product and/or component. Examples thereof include fitting local reinforcements of force-introducing elements into holes or the draping of a window frame on a fuselage shell.

For certain applications, it may even be desirable to regulate the temperature (heat or cool) a semi-finished product or component as uniformly as possible over the surface thereof by an end effector or else to compact the semi-finished product or component.

### BRIEF DESCRIPTION OF THE DRAWINGS

FIG. 1 is a schematic view of a flexible container to which a sheet-like gripper is attached; and

FIG. 2 is a schematic view of an aspect of the present invention incorporating a plurality of discrete gripper elements.

### DETAILED DESCRIPTION OF THE INVENTION

Taking into consideration what has been stated above, it is an object of the present invention to provide an end effector which can be used for differently shaped semi-finished products or components and can, for example, efficiently grip said semi- finished products/components and deposit the latter in a precisely fitting manner in a mould or also can uniformly regulate the temperature of or compact said semi-finished products/components. It is a further object of the present invention to provide a suitable method using the end effector according to the invention.

According to a first aspect of the present invention, the object is achieved by providing an end effector, comprising
a flexible container which contains a filler, wherein the filler is switchable between a flowable or deformable state and a rigid or dimensionally stable state, and
one or more working elements for gripping, temperature regulation and/or compaction.

As is described in even more detail below, the end effector according to the invention makes it possible to copy the surface contour of the depositing surface of a mold or else the surface contour of a component or semi-finished product in the flexible container by the flexible container being pressed against the depositing surface or the component (i.e. filler in a flowable or plastically or elastically deformable state), and subsequently “to freeze” the surface contour copied in the flexible container (transfer the filler into the rigid or dimensionally stable state). Subsequently, for example, an object gripped with gripper elements, such as, for example, a textile fabric or a prepreg, can be deposited as exactly as possible on the depositing surface of the mold. If the end effector is intended to be used at a later time for a new depositing surface having a different surface contour, the filler can be transferred again into a flowable or elastically or plastically deformable state in order to copy the new surface contour, followed by the “freezing” of the copied surface contour by the filler being switched again into the solidified state. After the “freezing” of the surface contour of a component or semi-finished product, the end effector can also be used to regulate the temperature of the component or semi-finished product as uniformly as possible, for example by means of heating elements which are attached on the surface of the flexible container.

Within the context of the present invention, the term “end effector” is understood in its customary meaning familiar to a person skilled in the art and therefore refers in robotics to the final element in a kinematic chain.

Within the context of the present invention, “rigid” or “dimensionally stable” is understood as meaning a state in which the filler under the action of the external force actions (gravitational force and/or pressing by the robot into a contoured shape) to be anticipated during the process sequence is no longer capable of adapting to the geometry of a container (i.e. is no longer sufficiently flowable).

Within the context of the present invention, “flowable” or “deformable” (elastically or plastically) is understood as meaning a state in which the filler under the action of the external force actions (gravitational force and/or pressing by the robot into a contoured shape) to be anticipated during the process sequence is still capable of adapting to the geometry of a container.

Within the context of the present invention, customary liquids should therefore be regarded as flowable. Furthermore, however, particulate solids, such as powder or solid pellets, should also be regarded as flowable if the interactions between the particles (for example strong adhesion of the particles/pellets to one another) is not pronounced to an extent such that flowability is prevented.

As explained above, the filler present in the flexible container is selected from those materials which can be switched between a flowable or elastically or plastically deformable state and a rigid state. This switchability permits a change in the state in both directions, i.e., for example, from flowable to rigid and at a later time back again to flowable.

The transfer of the material from the flowable or deformable state into the rigid or dimensionally stable state (or vice versa) is realized by a suitable external effect, for example by changing the pressure, such as applying a vacuum, changing the temperature, changing the electrical field, for example by applying a voltage, etc.

Suitable materials which can be switched between a flowable and a rigid state, and also suitable external parameters, the change in which brings about the transfer from flowable to rigid or rigid to flowable are basically known to a person skilled in the art.

In a preferred embodiment, the filler is a particulate solid.

In this case, it is preferred if the particulate solid has a low density and, in the normal state, has sufficient flowability and can therefore be adapted to different geometries without any problem and, upon application of a vacuum to the flexible container, can be rapidly transferred into a rigid state.

Preferred particulate solids which meet these requirements are, for example, foam particles, in particular foam pellets, i.e. polymer pellets which have been produced by a foaming process.

Suitable foam pellets are, for example, STYROPOR® pellets.

Coarse-grained solids are likewise suitable as the filler.

Depending on the surface contour, which is intended to be copied with the flexible container of the end effector (for example degree of surface curvature, etc.), the average diameter of the foam pellets can vary over a wide range.

A powder (for example a coarse-grained powder) can also be used as a particulate filler.

In an alternative preferred embodiment, the filler is a liquid, in particular an electroviscous liquid.

Electroviscous liquids are basically known to a person skilled in the art. In general, said liquids are present in the form of dispersions of fine hydrophilic solids in hydrophobic liquids. The particular characteristic of said liquids consists in that the flow behaviour thereof and therefore the viscosity thereof can be changed within wide limits by application of an electrical field. Examples of areas of use of electroviscous liquids lie in the field of industrial and vehicle hydraulics, for example for the mounting of machines and engines or for damping, for a vehicle ride-height control system, suspension system of a vehicle and damping of a vehicle, and also for torque converters and automatic clutches.

The electroviscous liquids generally contain three components, a disperse phase which contains, for example, silicates, zeolites, titanates, semiconductors, polysaccharides or organic polymers, an electrically non-conductive hydrophobic liquid as the liquid phase, and also a dispersing agent.

Alternatively, a liquid which can be switched between a flowable and a rigid or dimensionally stable state by changing the temperature is used as the filler. The term “liquid” then preferably refers to a substance present as a liquid at room temperature and atmospheric pressure.

The liquid can also contain a particulate solid (for example foam pellets, such as STYROPOR® pellets, magnetic particles, etc.) in order, inter alia, to obtain weight savings or the functionality of switching between rigid and liquid.

A combination of the abovementioned fillers is likewise possible.

As already discussed above, the reversible switching between a flowable and rigid state can be brought about by a corresponding change in a suitable external parameter, such as pressure, temperature and/or electrical field.

For this purpose, the end effector preferably comprises a switching element via which the external parameter can be correspondingly changed.

Suitable switching elements which can be used include, for example, one or more vacuum lines or ventilation lines, one or more heating elements and/or electrodes. Said switching elements are preferably attached to the flexible container or embedded in the surface thereof.

Parameters such as pressure, temperature or electrical field strength in the flexible container can be varied via said switching elements in such a manner that the filler is transferred from the flowable state into the rigid state or from the rigid state into the flowable state.

The degree of filling of the flexible container can be varied over a wide range depending on the type of filler and the surface contour to be copied of a depositing surface.

For example, a range of 30% to 100% can be indicated as a suitable degree of filling. The flexible container can therefore be completely filled with filler or alternatively can have a degree of filling <100%, for example 30-90%.

A suitable parameter for the change in state from flowable to rigid or rigid to flowable can be selected with knowledge of the particular filler.

When a particulate solid is used, in particular foam pellets, such as, for example, STYROPOR® pellets, as the filler, the change in state of the filler is preferably brought about by a change in pressure. The transition of flowable to rigid is preferably brought about by application of a negative pressure or a vacuum to the flexible container while the transition rigid to flowable can be realized by corresponding ventilation of the flexible container.

The amount of filling or the degree of filling is preferably selected in such a manner that the particles or pellets remain movable and flowable among one another and therefore the entire container is deformable. If the flexible container is pressed against a contour of arbitrary shape, said container reproduces exactly this surface. If a vacuum or a suitably set negative pressure is then produced in said container, the particles or pellets are greatly compacted and lose their movement clearance. The strong compaction or the “wedging” of the particles/pellets finally causes the filler in the container to solidify and therefore the container itself is also no longer freely deformable.

When a particulate solid is used, in particular foam pellets, such as, for example, STYROPOR® pellets, as the filler, it is therefore preferred that at least one vacuum or ventilation line is attached to the flexible container or is embedded in the surface thereof. Said line is connected to a vacuum pump in order thereby to be able to produce a sufficient negative pressure or a vacuum in the flexible container.

When an electroviscous liquid is used, electrodes for producing an electrical field are preferably attached to the flexible container or are embedded in the surface thereof. The electrodes are connected to a voltage source and, upon application of a suitable electric voltage, an electrical field is thereby produced in the flexible container, which leads to a corresponding solidification of the electroviscous liquid.

If the change in state from flowable to rigid or rigid to flowable is brought about by a change in temperature in the flexible container, heating and/or cooling elements are preferably attached to the flexible container or embedded in the surface thereof. In this case, the change in state can be brought about, for example, by the filler being reversibly melted and crystallized. By heating to a temperature above the melting point, the filler is kept flowable, while cooling to a temperature below the melting point brings about solidification of the filler (by crystallization).

As explained above, the container in which the switchable filler is present is a flexible container. Within the context of the present invention, this is understood as meaning a container with a flexible wall. Such flexible containers or containers with a flexible wall are known to a person skilled in the art and are used in a multiplicity of different applications. A flexible wall can be ensured by the choice of suitable wall materials. Examples which can be mentioned here include textile materials, film- or membrane-like materials, such as, for example, a vacuum film, a silicone membrane, an “Fill” fabric or a “ZERO P”, or combinations of said materials.

Depending on the type of filler and the parameter which brings about the change in state, it may be necessary for the material from which the flexible container is manufactured to meet certain requirements. If, for example, the change in state is brought about by application of a negative pressure or a vacuum (preferably in the case of use of a particulate solid, such as, for example, foam pellets), the flexible container should have a wall which is as gas-tight as possible. If the flexible container is filled with a liquid as the filler, the flexible container should have a wall which is as liquid-impermeable as possible. Suitable flexible materials which satisfy the requirements are basically known to a person skilled in the art.

The flexible container filled with the filler can be configured in a highly variable manner in respect of the shape thereof. It is important that the container has sufficient flexibility such that, when the container is pressed onto an arbitrary surface contour, said surface is copied by the container as exactly as possible.

In a preferred embodiment, the flexible container has a base of defined shape, for example rectangular, square or hexagonal.

In order to increase the variability in respect of the possible applications, in a preferred embodiment the end effector comprises two or more flexible containers which are joined to one another and preferably have a base or boundary surface of defined shape (for example rectangular, square or hexagonal). By means of the base of defined shape, the flexible containers can be arranged next to one another in an effective manner. The bases of each flexible container preferably have the same shape, but may differ in respect of area.

By means of this modular construction, different bases can be plugged together under constant control of the end effector and can thus be adapted in a simple manner to different sizes of semi-finished product and/or component.

As explained above, the end effector comprises at least one working element for gripping and/or temperature-regulating and/or compacting, for example, a semi- finished product or component.

Suitable working elements for gripping, which can be used in end effectors, are basically known to a person skilled in the art in the form of gripper elements.

Examples which can be mentioned in this context include vacuum grippers, needle grippers, ice grippers, Bernoulli grippers, suspended grippers or ultrasonic grippers. Furthermore, it is possible to use magnetic and/or inductive effects for gripping (magnetic grippers).

The gripper element or the gripper elements are or is preferably attached in the end effector in such a manner that a semi-finished product and/or component to be gripped is fixed in that region of the flexible container in which the surface contour of the depositing surface is copied.

The gripper elements are preferably fastened to the flexible container or are embedded in the surface thereof.

In a preferred embodiment, the gripper element, preferably a vacuum gripper element, is designed as a sheet-like gripper element.

The sheet-like gripper element is preferably attached on the side of the flexible container which faces the semi-finished product and/or component or the depositing surface. Depending on the size of the semi-finished product and/or component to be gripped, the area of the sheet-like gripper element may vary over a wide range. The area of the sheet-like gripper element may lie, for example, within the range of 20 cm² to 2 m².

In a preferred embodiment, the sheet-like gripper element is connected to a vacuum line and is manufactured from a porous or air-permeable material (for example a textile fabric or textile knit, a spacer fabric or space knit) such that, when a vacuum is applied to the surface of the sheet-like gripper element, a suction is produced, by means of which the semi-finished product and/or component to be gripped, for example a textile fiber material, is fixed on the surface of the sheet-like gripper element.

In a preferred embodiment, the sheet-like gripper element is realized by a spacer fabric or spacer knit which is preferably fastened on the surface of the flexible container and is connected to a vacuum line.

Spacer fabrics or spacer knits are basically known to a person skilled in the art. They customarily comprise two fabric top layers which are kept at a certain distance by space-maintaining web threads.

The spacer fabric preferably affords a certain degree of compression resistance. As a result, the molding accuracy is maintained. By applying a negative pressure or vacuum to the spacer fabric, a suction is produced over the entire, slightly porous or air-permeable surface of the spacer fabric, the suction securing the semi-finished product and/or component to be gripped. The compression resistance of the spacer fabric in turn ensures that the airflow in the interior of the spacer fabric is uniform and that there are no regions at which the suction effect is lost.

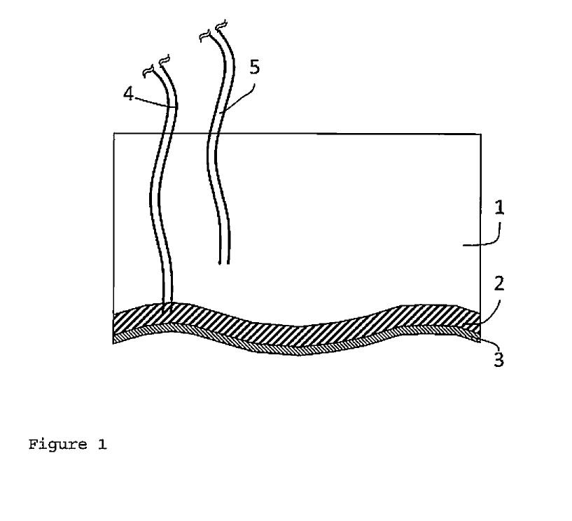

A flexible container to which a sheet-like gripper element is attached is illustrated schematically in FIG. 1. The flexible container 1 is connected to a vacuum line 5. For example, foam pellets can be used as a possible filler. The flexible container is preferably configured in a gas-tight manner, for example by choosing suitable wall materials. A sheet-like gripper element 2 is attached to the flexible container 1. For example, this may involve a spacer fabric. Said spacer fabric is connected to a vacuum line 4. The vacuum lines 4 and 5 can operate independently of each other. If the end effector is then moved in the direction of the depositing surface of a mold in such a manner that the flexible container 1 is pressed with a sufficient press-on pressure against said depositing surface, the surface contour of the depositing surface is copied in the flexible container 1. Before the end effector is moved away again from the mold, a vacuum or negative pressure is applied in the flexible container 1 via the vacuum line 5. This brings about a contracting of the flexible container 1, and the foam pellets are so greatly compacted that the transfer from the flowable into the rigid state is brought about. In the rigid state, the surface contour is permanently copied in the flexible container 1 or in the spacer fabric 2 attached on the container. In said rigid state, the end effector is moved with respect to the semi-finished product and/or component 3 to be gripped. A pliant semi-finished product, for example a textile fiber material, is preferably involved. By application of a negative pressure in the spacer fabric 2, a suction is produced on the air-permeable surface thereof, the suction fixing the semi-finished product and/or component 3 to the sheet-like gripper element (i.e. the spacer fabric) 2.

When a sheet-like gripper unit is used, for example in the form of a spacer fabric, it may be sufficient if the end effector has only one gripper element or only one gripper element is attached to the flexible container or is embedded in the surface thereof.

Alternatively, it may be preferred for a plurality of individual gripper elements (for example vacuum grippers, needle grippers, ice grippers, Bernoulli grippers, suspended grippers, magnetic grippers and/or ultrasonic grippers) to be fastened to the flexible container or to be embedded in the surface thereof.

The control or control system of the gripper elements is preferably decoupled from the control or control system of the flexible container such that the flexible container is molded in one step and the gripping processes are then independent of said preparation step. The application of a vacuum to the flexible container filled with the filler is therefore not to be equated with a vacuum at the gripper elements.

In a preferred embodiment, a plurality of gripper elements (for example at least three or else at least four) can be fastened to the flexible container or embedded in the surface thereof in a defined arrangement with respect to one another. As a result, a defined arrangement pattern (for example triangular, square, etc.) is formed and, by means of the grid-shaped arrangement of a plurality of gripper elements, the semi-finished product and/or component to be gripped and transported is held at a plurality of points. In this case, a different number of gripper elements is used depending on the size of the semi-finished product and/or component.

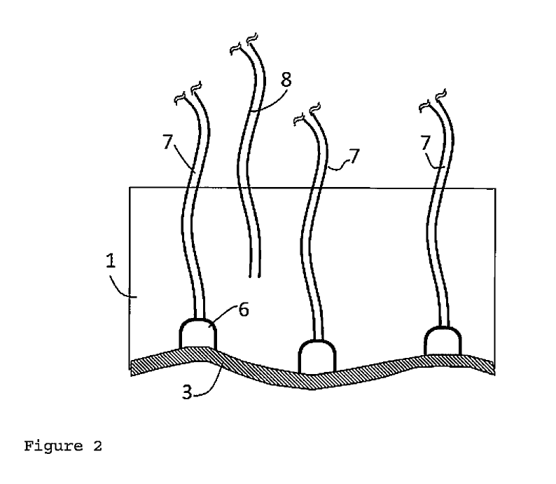

One possible configuration of the preferred embodiment with a plurality of discrete gripper elements arranged in a grid-shaped manner is illustrated schematically in FIG. 2. The flexible container 1 is connected to a vacuum line 8. Foam pellets, for example, can be used as a possible filler. A plurality of discrete gripper elements 6 arranged in a grid-shaped manner are attached to the flexible container 1. For example, vacuum grippers can be involved here. The vacuum grippers 6 are each connected to a vacuum line 7. The vacuum lines 7 and 8 can operate independently of one another. If the end effector is now moved in the direction of the depositing surface of a mold in such a manner that the flexible container 1 is pressed against said depositing surface with a sufficient press-on pressure, the surface contour of the depositing surface is copied in the flexible container 1. Before the end effector is moved away again from the mold, a vacuum or negative pressure is applied in the flexible container 1 via the vacuum 8. This causes a contraction of the flexible container 1, and the foam pellets are so greatly compacted that the transfer from the flowable into the rigid state is brought about. In the rigid state, a permanent copy of the surface contour in the flexible container 1 occurs. In said rigid state, the end effector is moved with respect to the semi-finished product and/or component 3 to be gripped. This preferably involves a pliant or limp textile semi-finished product, for example a textile fiber material. By application of a negative pressure or vacuum in the gripper elements 6 arranged in a grid-shaped manner, the semi-finished product and/or component 3 is fixed to the flexible container 1.

As already mentioned above, the end effector can have one or more heating and/or cooling elements. These are preferably fastened to the flexible container or are embedded in the surface thereof. These may also be attached as individual heating elements in the shape of a grid or in a sheet-like manner, for example in the form of heatable or temperature-regulable films or layers between the flexible container and the semi-finished product to be transported.

In a specific embodiment, the above-described spacer fabric can be flushed with temperature-regulated air and/or an air-permeable fabric provided with heating wires can be fastened on the spacer fabric. The heating is preferably independent of the gripper elements, i.e. the flexible container can be used only with a heating system, only with gripper elements or else in any combination of gripping and temperature regulation.

If the change in state from flowable to rigid or rigid to flowable is brought about by a change in temperature in the flexible container, this can preferably be undertaken by the heating and/or cooling elements described above.

In the case of a bound semi-finished product, the heating and/or cooling elements can also be used to obtain binder activation.

In the case of a prepreg, the heating and/or cooling elements can be used to suppress a crosslinking reaction.

According to a further aspect of the present invention, a robot is provided, the robot having one or more of the end effectors described above.

As is generally customary, the end effector can be fastened to the end of a pivotable robot arm. As a further preferred embodiment, a portal construction is also possible.

According to a further aspect of the present invention, a method for gripping, temperature-regulating and/or compacting a semi-finished product and/or component is provided, comprising:
providing the end effector described above, wherein the filler present in the flexible container is in a flowable or deformable state,
pressing the flexible container onto a depositing surface of a mold or onto a surface of a component or semi-finished product, wherein the press-on pressure is of a magnitude sufficient in order to copy the surface contour of the depositing surface or of the component or semi-finished product into the flexible container,
transferring the filler from the flowable or deformable state into the rigid or dimensionally stable state, and
gripping, temperature-regulating and/or compacting the semi-finished product or component by the working element of the end effector.

As already explained above, the method using the end effector according to the invention can copy the surface contour of the depositing surface of a mold or else the surface contour of a component or semi-finished product in the flexible container by the flexible container being pressed against the depositing surface or the component (i.e. filler in a flowable or plastically or elastically deformable state) and said surface contour copied in the flexible container subsequently being “frozen” (transfer of the filler into the rigid or dimensionally stable state). Subsequently, for example, an object gripped with gripper elements, such as, for example, a textile fabric or a prepreg, can be deposited as exactly as possible on the depositing surface of the mold. If the end effector is intended to be used at a later time for a new depositing surface with a different surface contour, the filler can be transferred again into a flowable or elastically or plastically deformable state in order to copy the new surface contour, followed by the “freezing” of said copied surface contour by the filler being switched again into the solidified state. After the “freezing” of the surface contour of a component or semi-finished product, the end effector can also be used to regulate the temperature of said component or semi-finished product as uniformly as possible, for example by means of heating elements which are attached on the surface of the flexible container.

When the method is used for gripping and depositing a semi-finished product and/or component, said method preferably comprises the following steps:
providing the end effector described above, wherein the filler present in the flexible container is in a flowable or deformable state,
pressing the flexible container onto a depositing surface of a mold, wherein the press-on pressure is of a magnitude sufficient in order to copy the surface contour of the depositing surface,
transferring the filler from the flowable or deformable state into the rigid or dimensionally stable state,
gripping a semi-finished product or component with a gripper element or gripper elements in order to fix the semi-finished product or component in the region of the copied surface contour of the depositing surface,
transporting the semi-finished product or component to the mold, and
depositing the semi-finished product or component in the mold.

In a preferred embodiment, the semi-finished product is a pliant or limp material. Examples which can be mentioned in this connection include a prepreg, preforms, a semi-finished fiber product, textile mats and/or components.

With regard to the preferred features of the end effector, reference may be made to the explanations above at this juncture.

As already explained above, the filler is transferred from the flowable state into the rigid state (or vice versa) by a suitable exterior action, for example by changing the pressure, such as applying a negative pressure or vacuum, changing the temperature, changing the electrical field, such as, for example, by applying a voltage, in the flexible container. With regard to preferred embodiments, reference is made to the explanations above.

The gripper element or the gripper elements are/is preferably fastened to the flexible container or embedded in the surface thereof in such a manner that the gripped semi-finished product and/or component is fixed as efficiently as possible in the region of the flexible container in which the surface contour of the depositing surface of the mold is copied.

As described above, the present invention makes it possible to vary between a soft, i.e. deformable, surface of the gripper unit and a tough or rigid and dimensionally stable surface of the gripper unit. This affords the advantage that different contours and degrees of complexity (a different semi-finished product and/or components or different steps within a semi-finished product and/or component) can be attended to with just one tool system when handling pliant materials. Furthermore, there is the possibility, by means of the modularity of the system, of attending to different sizes of semi-finished products and/or components with one tool system. For small batch sizes or semi-finished product and/or components which are assembled from differently sized blanks, individual preforms or subcomponents (sandwich cores, inserts and the like), the provision of individually adapted tools is therefore dispensed with. This affords a great advantage in terms of costs.

By means of the option of combining different types of gripper (for example needle grippers and vacuum grippers, etc.), quality enhancements in the depositing accuracy can be obtained. In one of the preferred embodiments, a contour-true, sheet-like mounting by means of a vacuum in the spacer fabric prevents local slipping and/or a distortion in the fiber semi-finished product or in the preform. Needle grippers can ensure additional support at points where, for example, thickened portions, bracings or add-on parts are to be provided and the retaining force of the vacuum by itself would not be sufficient.

With the use of vacuum storage systems, very rapid laying processes can be realized such that an increase in speed, an increase in the throughput rate and therefore finally in the productivity is made possible.

The temperature regulability can be advantageous for chemical processes. For example, heating can be used to control binder activation or a partial or straight-through reaction of a resin and cooling can be used to suppress a crosslinking reaction.

What is claimed is:

1-16. (canceled)

17. An end effector comprising:
a flexible container which contains a filler, wherein the filler is switchable between a flowable or deformable state and a rigid or dimensionally stable state, and
one or more working elements for gripping, temperature regulation, compaction, or a combination thereof.

18. The end effector of claim 17, wherein the filler is a filler chosen from the group consisting of a particulate filler, a liquid, and combinations thereof.

19. The end effector of claim 17, wherein the filler is one or more fillers selected from foam particles, a powder, an electroviscous liquid, or combinations of said fillers.

20. The end effector of claim 18, wherein the filler is one or more fillers selected from foam particles, a powder, an electroviscous liquid, or combinations of said fillers.

21. The end effector of claim 17, wherein the end effector further comprises at least one switching element which is attached to the flexible container or is embedded in the surface thereof and the switching element is a switching element selected from the group consisting of: one or more vacuum lines; one or more ventilation lines; one or more heating elements; one or more cooling elements; electrodes; or combinations thereof.

22. The end effector of claim 20, wherein the end effector further comprises at least one switching element which is attached to the flexible container or is embedded in the surface thereof and the switching element is a switching element selected from the group consisting of: one or more vacuum lines; one or more ventilation lines; one or more heating elements; one or more cooling elements; electrodes; or combinations thereof.

23. The end effector of claim 22, wherein a degree of filling of the flexible container with the filler is 30-100%.

24. The end effector of claim 21, wherein the end effector comprises two or more flexible containers which are joined to each other and each have a base of a defined shape.

25. The end effector of claim 17, wherein the working element or the working elements are: fastened to the flexible container, embedded in the surface thereof or fastened to the flexible container and embedded in the surface thereof.

26. The end effector of claim 24, wherein the working element or the working elements are: fastened to the flexible container, embedded in the surface thereof, or fastened to the flexible container and embedded in the surface thereof.

27. The end effector of claim 26, wherein the working element for gripping is a gripper element chosen from the group consisting of: a vacuum gripper, needle gripper, ice gripper, Bernoulli gripper, suspended gripper, magnetic gripper, ultrasonic gripper, and combinations thereof.

28. The end effector of claim 27, wherein the gripper element is in the form of a spacer fabric and is designed as a sheet-like gripper element which is attached on the surface of the flexible container.

29. The end effector of claim 17, wherein the gripper element is in the form of a spacer fabric and is designed as a sheet-like gripper element which is attached on the surface of the flexible container.

30. The end effector of claim 28, wherein the working element for regulating the temperature is a heating element or a cooling element.

31. The end effector of claim 17 comprising a plurality of working elements, wherein the plurality of working elements are fastened to the flexible container or are embedded in the surface thereof in a defined arrangement with respect to one another.

32. A robot or a portal system having one or more end effectors of claim 30.

33. A robot or a portal system having a plurality of end effects of claim 17.

34. A method for gripping, temperature-regulating and/or compacting a semi-finished product and/or component, comprising the steps of:
providing an end effector of claim 1, wherein the filler present in the flexible container is in a flowable or deformable state,
pressing the flexible container onto a depositing surface of a mold or onto a surface of a component or semi-finished product, wherein the press-on pressure is of a magnitude sufficient in order to copy the surface contour of the depositing surface or of the component or semi-finished product into the flexible container,
transferring the filler from the flowable or deformable state into the rigid or dimensionally stable state, and
gripping; temperature-regulating; compacting; or a combination of gripping, temperature regulating and compacting the semi-finished product or component by the working element of the end effector.

35. The method of claim 34, wherein the pressing step comprises pressing the flexible container onto a depositing surface of a mold, wherein the press-on pressure is of a magnitude sufficient in order to copy the surface contour of the depositing surface the transferring step comprises transferring the filler from the flowable or deformable state into the rigid or dimensionally stable state and the gripping steps comprises gripping a semi-finished product or component with a gripper element or gripper elements in order to fix the semi-finished product or component in the region of the copied surface contour of the depositing surface; and
wherein the method further comprises the steps of:
transporting the semi-finished product or component to the mold: and
depositing the semi-finished product or component in the mold.

36. The method of claim 34, wherein the semi-finished product or component is a pliant semi-finished product or component.

37. The method of claim 35, wherein the semi-finished product or component is a pliant semi-finished product or component.

38. The method of claim 37, wherein the filler is transferred from the flowable or deformable state into the rigid or dimensionally stable state by changing the pressure, changing the temperature, changing the electrical field, or combinations thereof.
